(19) United States
(12) Patent Application Publication
(10) Pub. No.: US 2024/0340138 A1
(43) Pub. Date: Oct. 10, 2024

(54) METHOD AND DEVICE USED FOR WIRELESS COMMUNICATION

(71) Applicants: Lin YANG, Shanghai (CN); Xiaobo ZHANG, Shanghai (CN)

(72) Inventors: Lin YANG, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/624,136

(22) Filed: Apr. 2, 2024

(30) Foreign Application Priority Data
Apr. 4, 2023 (CN) 202310354230.7

(51) Int. Cl. H04L 5/00; H04B 7/06; H04W 72/0453

(52) U.S. Cl. CPC H04L 5/0051; H04B 7/0626; H04B 7/0639; H04W 72/0453

(57) ABSTRACT

The present application provides a method and a device used for wireless communications. A first node receives a first RS; determines first reference quality, where the first reference quality depends on non-codebook precoding information; receives a second RS, where the second RS is linked with the first RS; transmits a first message, the first message depends on a comparison between received quality of the second RS and the first reference quality; wherein both the first reference quality and the non-codebook precoding information depend on a measurement for the first RS. The present application can ensure the performance monitoring of channel information and avoid consuming excessive radio overhead while providing good compatibility.

### CROSS REFERENCE TO RELATED APPLICATIONS

This application claims the priority benefit of Chinese Patent Application No. 202310354230.7, filed on Apr. 4, 2023, the full disclosure of which is incorporated herein by reference.

### BACKGROUND

### Technical Field

The present application relates to methods and devices in wireless communication systems, and in particular to a scheme and device for Channel Status Information (CSI) in a wireless communication system.

### Related Art

In traditional wireless communications, UE (User Equipment) reporting may comprise at least one of a variety of auxiliary information, such as CSI (Channel Status Information), Beam Management related auxiliary information, positioning related auxiliary information and so on. And CSI comprises a CRI (CSI-RS Resource Indicator), an RI (Rank Indicator), a PMI (Precoding Matrix Indicator) or a CQI (Channel quality indicator) and so on.

The network equipment selects appropriate transmission parameters for the UE based on the UE reporting, such as a camping cell, an MCS (Modulation and Coding Scheme), a TPMI (Transmitted Precoding Matrix Indicator), a TCI (Transmission Configuration Indication) and other parameters. In addition, the UE reporting can be used to optimize network parameters, such as better cell coverage, switching base stations based on UE location, etc.

In NR (New Radio) system, the priority of CSI reports is defined, and the priority is used to determine whether CPU (CSI Processing Unit) resources are assigned to a corresponding CSI report for updating or whether a corresponding CSI report is dropped.

As the number of antennas increases, the traditional PMI feedback approach introduces a large amount of redundancy overhead, therefore, CSI compression based on AI (Artificial Intelligence) or ML (Machine Learning) was projected in NR R (release) 18.

### SUMMARY

In the traditional scheme, the base station configures a reported CSI type for an RS (Reference Signal) resource. The applicant has found through researches that existing schemes used for CSI may not be applicable to new channel information.

To address the above problem, the present application provides a solution. It should be noted that although a large number of embodiments in the present application are directed to AI/ML, the present application is also applicable to schemes based on traditional schemes, e.g., based on linear channel reconstruction; in particular, it is considered that specific channel reconstruction algorithms are likely to be non-standardized or self-implemented by hardware equipment vendors. Further, the adoption of a unified UE (User Equipment, User) reporting scheme can reduce implementation complexity or improve performance. If no conflict is incurred, embodiments in any node and the characteristics of the embodiments in the present application are also applicable to any other node, and vice versa. And the embodiments and the characteristics in the embodiments in the present application can be arbitrarily combined if there is no conflict.

Where required, the explanation of the terms in the present application can be referred to the description of 3GPP (3rd Generation Partner Project) TS37 series as well as TS38 series.

The present application provides a method in a first node for wireless communications, comprising:
receiving a first RS; determining first reference quality, where the first reference quality depending on non-codebook precoding information; receiving a second RS, where the second RS being linked with the first RS; and
transmitting a first message, the first message depending on a comparison between received quality of the second RS and the first reference quality;
herein, both the first reference quality and the non-codebook precoding information depend on a measurement for the first RS.

One advantage of the above method is that the first node determines the first message based on the comparison between the received quality of the second RS and the first reference quality, resulting in a faster response speed.

In one embodiment, the non-codebook precoding information complies with at least one of the following:
channel parameters recovered by a transmitter of the first RS based on the non-codebook precoding information are unknown to the first node;
channel parameters recovered by the first node based on the non-codebook precoding information are unknown to a transmitter of the first RS;
a generator used to generate the non-codebook precoding information is obtained based on training;
the non-codebook precoding information does not belong to a CSI defined by 3GPP Rel-17 or earlier versions of 3GPP Rel-17.

One advantage of the above method is that unnecessary channel information redundancy from feedback of the first node is avoided, so as to improve spectral efficiency.

Specifically, according to one aspect of the present application, the above method is characterized in comprising:
receiving a second message;
herein, the second message is used to determine at least one of the following:
a multi-antenna transmission of the second RS is codebook-based;
the second message is used to indicate a first precoding matrix, the first precoding matrix is codebook-based, and the first precoding matrix is used for the multi-antenna transmission of the second RS;
the second RS is linked with the first RS.

The above method is beneficial for providing higher scheduling flexibility for a transmitter of the first RS.

Specifically, according to one aspect of the present application, the above method is characterized in that as a response to a first condition being satisfied, the first message is triggered;
herein, the first condition depends on the comparison between the received quality of the second RS and the first reference quality.

The above method ensures the timeliness of feedback on the one hand, and avoids the radio redundancy caused by frequent feedback on the other.

Specifically, according to one aspect of the present application, the above method is characterized in comprising:
transmitting the non-codebook precoding information.

In one embodiment, the non-codebook precoding information only occupies one physical-layer channel.

In one embodiment, the non-codebook precoding information occupies multiple physical-layer channels.

Specifically, according to one aspect of the present application, the above method is characterized in that the generation of the first reference quality is based on: a wireless transmission corresponding to the first reference quality is adjusted for a first offset compared to transmit power of the first RS; the first offset is linked with the second RS.

In one embodiment, the second message is used to indicate the first offset.

Specifically, according to one aspect of the present application, the above method is characterized in comprising:
transmitting a first CQI;
herein, a generation of the first CQI is based on: transmit power of a PDSCH (Physical downlink shared channel) is adjusted for a second offset compared to transmit power of the first RS.

Specifically, according to one aspect of the present application, the above method is characterized in that the first reference quality depends on at least one of time-domain resources occupied by the second RS or frequency-domain resources occupied by the second RS.

The above methods can ensure fairness or flexibility of the comparison.

Specifically, according to one aspect of the present application, the above method is characterized in that a calculation of the first reference quality is conditional on a number of antenna port(s) of the second RS.
a number of the antenna port(s) is sometimes referred to as a number of MIMO layer(s) or a number of RS port(s).

The above methods can ensure fairness or flexibility in comparison and reduce the radio overhead of signaling.

The present application provides a method in a second node for wireless communications, comprising:
transmitting a first RS; transmitting a second RS, where the second RS being linked with the first RS;
receiving a first message, the first message depending on a comparison between received quality of the second RS and first reference quality;
herein, the first reference quality depends on non-codebook precoding information; both the first reference quality and the non-codebook precoding information depend on a measurement for the first RS.

Specifically, according to one aspect of the present application, the above method is characterized in comprising:
transmitting a second message;
herein, the second message is used to determine at least one of the following:
a multi-antenna transmission of the second RS is codebook-based;
the second message is used to indicate a first precoding matrix, the first precoding matrix is codebook-based, and the first precoding matrix is used for the multi-antenna transmission of the second RS;
the second RS is linked with the first RS.

Specifically, according to one aspect of the present application, the above method is characterized in comprising:
receiving the non-codebook precoding information.

Specifically, according to one aspect of the present application, the above method is characterized in comprising:
receiving a first CQI;

herein, a generation of the first CQI is based on: transmit power of a PDSCH is adjusted for a second offset compared to transmit power of the first RS.

Specifically, according to one aspect of the present application, the above method is characterized in that a calculation of the first reference quality is conditional on a number of antenna port(s) of the second RS.

The present application provides a first node for wireless communications, comprising:
a first receiver, receiving a first RS; determining first reference quality, where the first reference quality depending on non-codebook precoding information; receiving a second RS, where the second RS being linked with the first RS; and
a first transmitter, transmitting a first message, the first message depending on a comparison between received quality of the second RS and the first reference quality;
herein, both the first reference quality and the non-codebook precoding information depend on a measurement for the first RS.

The present application provides a second node for wireless communications, comprising:
a second transmitter, transmitting a first RS; transmitting a second RS, where the second RS being linked with the first RS; and
a second receiver, receiving a first message, the first message depending on a comparison between received quality of the second RS and first reference quality;
herein, the first reference quality depends on non-codebook precoding information; both the first reference quality and the non-codebook precoding information depend on a measurement for the first RS.

### BRIEF DESCRIPTION OF THE DRAWINGS

Other features, objects and advantages of the present application will become more apparent from the

detailed description of non-restrictive embodiments taken in conjunction with the following drawings:

FIG. 1 illustrates a flowchart of communications of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of hardware modules of a communication node according to one embodiment of the present application;

FIG. 5 illustrates a flowchart of transmission between a first node and a second node according to one embodiment of the present application;

FIG. 6 illustrates a flowchart of transmitting a first CSI according to one embodiment of the present application;

FIG. 7 illustrates a schematic diagram of time-domain resources occupied by the first RS and the second RS according to one embodiment of the present application;

FIG. 8 illustrates a schematic diagram of CSI reference resources on frequency domain according to one embodiment of the present application;

FIG. 9 illustrates a schematic diagram of an artificial intelligence processing system according to one embodiment of the present application;

FIG. 10 illustrates a schematic diagram of a transmission of first channel information according to one embodiment of the present application;

FIG. 11 illustrates a schematic diagram of a first encoder according to one embodiment of the present application;

FIG. 12 illustrates a schematic diagram of a first function according to one embodiment of the present application;

FIG. 13 illustrates a schematic diagram of a decoding layer group according to one embodiment of the present application;

FIG. 14 illustrates a structure block diagram of a processor in a first node according to one embodiment of the present application;

FIG. 15 illustrates a structure block diagram of a processor in a second node according to one embodiment of the present application;

FIG. 16 illustrates a flowchart of a measurement in a first RS resource according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of communications of a first node according to one embodiment of the present application, as shown in FIG. 1.

A first node 100 receives a first RS in step 101; determines first reference quality, where the first reference quality depends on non-codebook precoding information; receives a second RS, where the second RS is linked with the first RS; transmits a first message in step S102, the first message depends on a comparison between received quality of the second RS and the first reference quality;

In embodiment 1, both the first reference quality and the non-codebook precoding information depend on a measurement for the first RS.

In one embodiment, a calculation of the first reference quality is conditional on a number of antenna port(s) of the second RS.

In one embodiment, the received quality of the second RS is calculated based on a condition that a PDSCH (on CSI reference resources, or virtual) is transmitted by Q1 antenna port(s), where Q1 is a number of antenna port(s) used to transmit the second RS.

In one embodiment, the received quality of the second RS is calculated based on a condition that a PDSCH (on CSI reference resources, or virtual) is transmitted by one antenna port, and the non-codebook precoding information represents a precoding vector.

In one embodiment, the first RS is transmitted in a CSI-RS (Channel Status Information Reference Signal) resource.

In one embodiment, the first RS comprises an SSB.

In one embodiment, the measurement for the first RS comprises a channel measurement.

In one embodiment, the measurement for the first RS comprises an interference measurement.

In one embodiment, the first reference quality and the received quality of the second RS are both CQI indexes.

In one embodiment, the first reference quality is a CQI index calculated conditioned on that the non-codebook precoding information is used to precode a PDSCH (on CSI reference resources, or virtual).

In one embodiment, the first reference quality is a CQI index calculated conditioned on the non-codebook precoding information.

In one embodiment, the received quality of the second RS is a CQI index.

In one embodiment, the received quality of the second RS is calculated conditioned on a number of antenna port(s) for transmitting the second RS.

In one embodiment, the received quality of the second RS is calculated conditioned on that a PDSCH (on CSI reference resources, or virtual) is transmitted by a first antenna port group, and the first antenna port group is one or multiple antenna ports transmitting the second RS.

Generally speaking, how to calculate the CQI index is implementation related, which is left to each manufacturer to determine on their own; a non-limiting embodiment is described below:
the first node N1 first measures a downlink RS (e.g., the first RS) to obtain a raw channel matrix H_{r×t}, where r, t are respectively a number of receiving antenna(s) and a number of antenna port(s) used for transmission; under the condition that a precoding matrix V_{t×l} is adopted, a pre-coded channel parameter matrix is H_{r×t}·V_{t×l}, where l is a number of rank(s) or layer(s), and the precoding matrix V_{t×l} is the non-codebook precoding information or is represented by the non-codebook precoding information; equivalent channel capacity of H_{r×t}·V_{t×l} is calculated by adopting criterions, for example, SINR (Signal Interference Noise Ratio), EESM (Exponential Effective SINR Mapping), or RBIR (Received Block mean mutual Information Ratio); a CQI index is determined by the equivalent channel capacity through looking up tables, etc.

It is to be noted that the calculation of the equivalent channel capacity may also take into account an estimation of noise and interference of the first node N1, and if the downlink RS comprises RS resources used for interference measurements, the first node N1 may utilize these RS resources to measure interference or noise more accurately.

In one embodiment, for the received quality of the second RS, a precoding operation is omitted, that is, an equivalent channel capacity of H_{r×t} (instead of H_{r×t}·V_{t×l}) is calculated and a CQI index is obtained through looking up tables.

In one embodiment, the first reference quality is measured by W, and the received quality of the second RS is measured by W.

In one embodiment, the first reference quality is measured by dBm, and the received quality of the second RS is measured by dBm.

In one embodiment, the first reference quality is RSRP, and the received quality of the second RS is RSRP of the second RS.

In one embodiment, the first reference quality is RSRP that is calculated conditioned on the non-codebook precoding information.

In one embodiment, a calculation of the first reference quality comprises: RSRP (equivalent, or virtual) obtained assuming that the first RS is subjected to precoding of the non-codebook precoding information.

How to calculate the pre-coded RSRP based on an RS before precoding can generally be left to the device manufacturer to determine, i.e. no standardization is required, and a non-limiting implementation method is given below.

The first node 100 first measures the first RS to obtain a receiving signal S_{r×t}, where r, t are respectively a number of receiving antenna(s) and a number of antenna port(s) used for transmission; under the condition that a precoding matrix V_{t×l} is adopted, a receiving signal after precoding is P_{r×l}=S_{r×t}·V_{t×l}; where l is a number of rank(s) or layer(s), and the precoding matrix V_{t×l} is the non-codebook precoding information or is represented by the non-codebook precoding information; the first reference quality is RSRP of the pre-encoded receiving signal P_{r×l}.

In one embodiment, a reference point of the RSRP of the pre-encoded receiving signal P_{r×l} is an antenna connector of the first node 100.

In one embodiment, the RSRP of the pre-coded receiving signal P_{r×l} is based on a merging of receiving signals of antenna elements of a receiver branch.

The above two embodiments remain as compatible as possible with existing systems.

In one embodiment, the received quality is RSRQ (Reference Signal Received Quality).

In one embodiment, the received quality is an equivalent BLER (Block Error Rate) of a PDSCH calculated based on RSRP.

In one embodiment, the received quality is an equivalent BLER of a PDCCH (Physical Downlink Control Channel) calculated based on RSRP.

In one embodiment, the first RS is a CSI-RS, and the second RS is a DMRS (Demodulation reference signal).

In one embodiment, the first RS is a CSI-RS, and the second RS is a DMRS for a PDSCH.

In one embodiment, the first RS is a CSI-RS or an SSB, and the second RS is a CSI-RS.

In one embodiment, the second RS being linked with the first RS comprises: the second RS and the first RS are QCL (Quasi Co-located).

In one embodiment, the second RS being linked with the first RS comprises: an antenna port used for transmitting the second RS is QCL with an antenna port used for transmitting the first RS.

In one embodiment, a QCL type between the second RS and the first RS is either type A or type D.

In one embodiment, a QCL type between the second RS and the first RS comprises both type A and type D.

In one embodiment, the second RS being linked with the first RS comprises: a CSI reported for the first RS is used to generate the second RS.

In one embodiment, an RI reported for the first RS is used to determine a number of MIMO (Multiple Input Multiple Output) layer(s) of the second RS.

In one embodiment, precoding information reported for the first RS is used for precoding of the second RS; the precoding information is based on codebook (such as PMI) or non-codebook (such as CSI generated based on AI or ML).

In one embodiment, the non-codebook precoding information represents a non-codebook precoding matrix.

In one embodiment, a precoding matrix recovered by the base station and the UE based on the non-codebook precoding information is not ensured to be the same.

In one embodiment, the first node 100 does not transmit the non-codebook precoding information through an air interface.

In one embodiment, a generator of the non-codebook precoding information is obtained based on training.

In one embodiment, the non-codebook precoding information does not belong to a CSI defined by 3GPP Rel-17 or earlier versions of 3GPP Rel-17.

In one embodiment, multi-antenna transmission of the second RS is based on codebook.

It should be noted that the multi-antenna transmission is sometimes referred to as precoding, beamforming, or spatial filtering, and so on.

In one embodiment, the first RS is after the second RS.

In one embodiment, the first RS is before the second RS.

In one embodiment, the first RS is periodic, and the second RS is periodic.

In one embodiment, the first RS is periodic, and the second RS is one-shot.

In one embodiment, the first reference quality is transmitted not through a radio interface.

In one embodiment, the non-codebook precoding information is transmitted not through a radio interface.

In one embodiment, the second RS being linked with the first RS comprises: the first RS and the second RS are configured by a same RRC (Radio Resource Control) IE (Information Element).

In one embodiment, the second RS being linked with the first RS comprises: the first RS and the second RS are indicated by a same MAC (Medium Access Control) CE (Control Element).

In one embodiment, the first message is used to indicate that a difference value between received quality of the second RS and the first reference quality exceeds a specific threshold.

In one embodiment, the first message is used to indicate that received quality of the second RS exceeds a specific threshold compared to the first reference quality.

According to the received quality, a unit for measurement of the specific threshold is integer, or dB, or W; furthermore, if the received quality is BLER, the smaller the value, the better the received quality.

### Embodiment 2

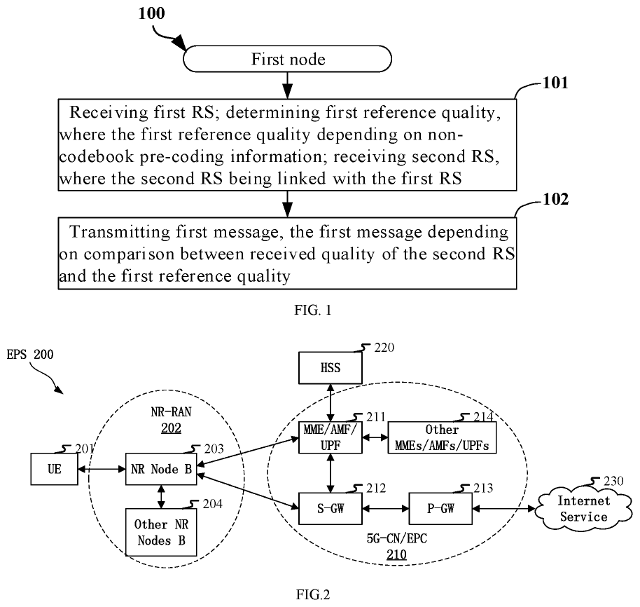

Embodiment 2 illustrates a schematic diagram of a network architecture according to one embodiment of the present application, as shown in FIG. 2. FIG. 2 illustrates the system architecture of 5G NR (New Radio), LTE (Long Term Evolution), and LTE-A (Long Term Evolution Advanced). The 5G NR or LTE network architecture 200 may be called a 5G System/Evolved Packet System (5GS/EPS) 5 or other appropriate terms. The EPS 200 may comprise UE 201, an NG-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application, and the gNB 203 corresponds to the second node in the present application.

In one embodiment, the UE 201 supports the use of AI (Artificial Intelligence) or Machine Learning to generate reports.

In one embodiment, the UE 201 supports using training data to generate a trained model or using trained data to generate partial parameters in a trained model.

In one embodiment, the UE 201 supports determining at least partial parameters of a CNN (Conventional Neural Networks) used for CSI reconstruction through training.

In one embodiment, the UE 201 supports determining a transformer used for CSI reconstruction through training.

In one embodiment, the UE 201 is a terminal supporting Massive-MIMO.

In one embodiment, the gNB 203 supports a transmission based on Massive-MIMO.

In one embodiment, the gNB 203 supports decompression of CSI by using AI or deep learning.

In one embodiment, the gNB 203 is a MarcoCellular base station.

In one embodiment, the gNB 203 is a Micro Cell base station.

In one embodiment, the gNB 203 is a PicoCell base station.

In one embodiment, the gNB 203 is a Femtocell.

In one embodiment, the gNB 203 is a base station that supports large delay differences.

In one embodiment, the gNB 203 is a flight platform.

In one embodiment, the gNB 203 is satellite equipment.

In one embodiment, the first node and the second node in the present application are respectively the UE 201 and the gNB 203.

### Embodiment 3

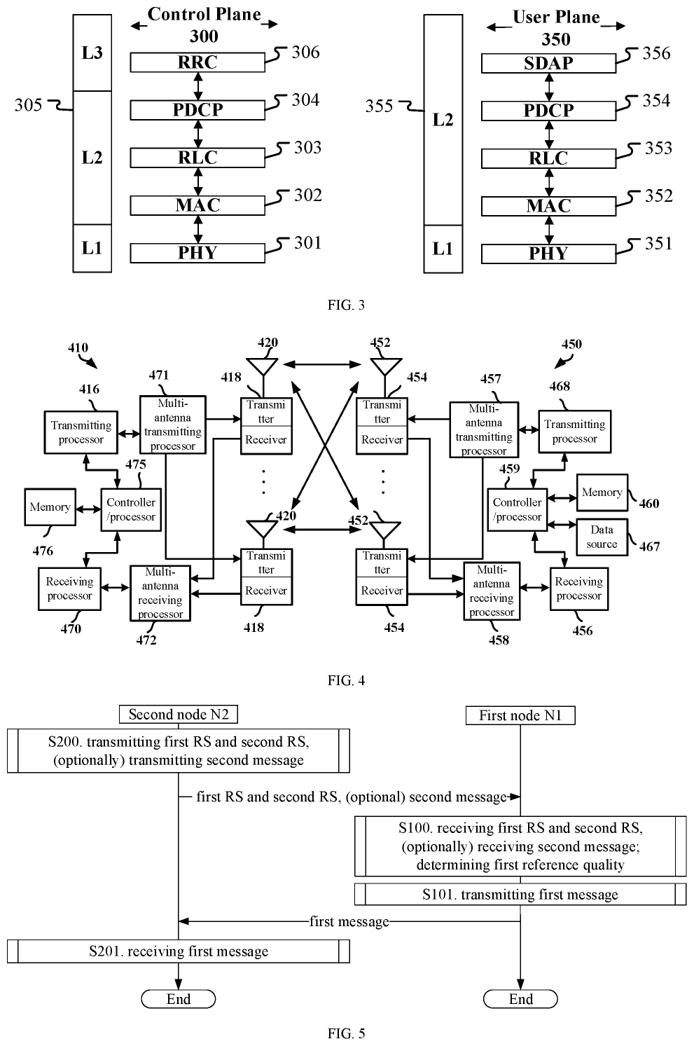

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first node (UE or RSU in V2X, vehicle equipment or On-Board Communication Unit) and a second node (gNB, UE or RSU in V2X, vehicle equipment or On-Board Communication Unit), or between two UEs is represented by three layers, which are respectively layer 1, layer 2 and layer 3. The layer 1 (L1) is the lowest layer and performs signal processing functions of various PHY layers. The L1 is called PHY 301 in the present application. The layer 2 (L2) 305 is above the PHY 301, and is in charge of the link between the first node and the second node, and between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the second nodes. The PDCP sublayer 304 provides data encryption and integrity protection and provides support for handover of a first node between second nodes. The RLC sublayer 303 provides segmentation and reassembling of a packet, retransmission of a lost data packet through ARQ, as well as repeat data packet detection and protocol error detection. The MAC sublayer 302 provides mapping between a logic channel and a transport channel and multiplexing of the logical channel. The MAC sublayer 302 is also responsible for allocating between first nodes various radio resources (i.e., resource block) in a cell. The MAC sublayer 302 is also responsible for HARQ operations. In the control plane 300, the RRC sublayer 306 in the L3 layer is responsible for acquiring radio resources (i.e., radio bearer) and configuring the lower layer using an RRC signaling between the second node and the first node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first node may comprise several higher layers above the L2 305, such as a network layer (i.e., IP layer) terminated at a P-GW of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, a first RS and a second RS in the present application is generated at the PHY 301.

In one embodiment, the non-codebook precoding information in the present application is generated at the PHY 301.

In one embodiment, the CSI in the present application is generated at the PHY 301.

In one embodiment, received quality of the second RS and the first reference quality in the present application are both calculated in the PHY 301.

In one embodiment, received quality of the second RS and the first reference quality in the present application are both calculated in the RRC 306.

In one embodiment, the first message in the present application is generated at the PHY 301.

In one embodiment, the first message in the present application is generated at the RRC sublayer 306.

In one embodiment, the first message in the present application is generated at the MAC sublayer 302.

### Embodiment 4

Embodiment 4 illustrates a schematic diagram of hardware modules of a communication node according to one embodiment of the present application; as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs channel coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 de-interleaves and channel decodes the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second node 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs channel coding, interleaving, and modulation mapping. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: receives a first RS; determines first reference quality, where the first reference quality depends on non-codebook precoding information; receives a second RS, where the second RS is linked with the first RS; transmits a first message, the first message depends on a comparison between received quality of the second RS and the first reference quality; herein both the first reference quality and the non-codebook precoding information depend on a measurement for the first RS.

In one embodiment, the first communication device 450 comprises at least one processor and at least one memory. a memory that stores a computer readable instruction program. The computer readable instruction program generates an action when executed by at least one processor. The action includes: receiving a first RS; determining first reference quality, where the first reference quality depending on non-codebook precoding information; receiving a second RS, where the second RS being linked with the first RS; transmitting a first message, the first message depending on a comparison between received quality of the second RS and the first reference quality.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: transmits a second RS, where the second RS is linked with the first RS; receives a first message, the first message depends on a comparison between received quality of the second RS and first reference quality; herein, the first reference quality depends on non-codebook precoding information; both the first reference quality and the non-codebook precoding information depend on a measurement for the first RS.

In one embodiment, the second communication device 410 comprises a memory that stores a computer readable instruction program. The computer readable instruction program generates an action when executed by at least one processor. The action includes: transmitting a second RS, where the second RS being linked with the first RS; receiving a first message, the first message depending on a comparison between received quality of the second RS and first reference quality; herein, the first reference quality depends on non-codebook precoding information; both the first reference quality and the non-codebook precoding information depend on a measurement for the first RS.

In one embodiment, the first communication device 450 corresponds to a first node in the present application.

In one embodiment, the second communication device 410 corresponds to a second node in the present application.

In one embodiment, the first communication device 450 is a UE, and the second communication device 410

is a base station.

In one embodiment, the antenna 452, the receiver 454, the multi-antenna receiving processor 458, and the receiving processor 456 are used for the measurement for the first RS.

In one embodiment, the controller/processor 459 is used for the measurement for the first RS resource.

In one embodiment, the controller/processor 459 is used to generate the non-codebook precoding information.

In one embodiment, the controller/processor 459 is used to generate the first message.

In one embodiment, the antenna 452, the transmitter 454, the multi-antenna transmitting processor 457, the transmitting processor 468, and the controller/processor 459 are used to transmit the first message.

In one embodiment, the antenna 420, the transmitter 418, the multi-antenna transmitting processor 471, and the transmitting processor 416 are used to transmit the first RS and the second RS.

In one embodiment, the controller/processor 475 is used to transmit the first RS and the second RS.

In one embodiment, the antenna 420, the receiver 418, the multi-antenna receiving processor 472, the receiving processor 470 and the controller/processor 475 is used to receive the first message.

### Embodiment 5

Embodiment 5 illustrates a flowchart of transmission between a first node and a second node, as shown in FIG. 5, in FIG. 5, steps in box F1 are optional.

The first node N1 receives a first RS in step S100; determines first reference quality; receives a second RS, where the second RS is linked with the first RS; transmits a first message in step S101, the first message depends on a comparison between received quality of the second RS and the first reference quality;
the second node N2 transmits a first RS in step S200; transmits a second RS, where the second RS is linked with the first RS; receives a first message in step S201, the first message depends on a comparison between received quality of the second RS and first reference quality:

in embodiment 5, the first reference quality depends on non-codebook precoding information; both the first reference quality and the non-codebook precoding information depend on a measurement for the first RS.

In one embodiment, the first RS and the second RS are respectively transmitted in two slots.

In one embodiment, the first RS is an aperiodic CSI-RS, and the second RS is an aperiodic CSI-RS.

In one embodiment, the first RS is a periodic CSI-RS, and the second RS is an aperiodic CSI-RS.

In one embodiment, the first RS is a periodic CSI-RS, and the second RS is an aperiodic DMRS.

In one embodiment, the execution time for determining first reference quality is self-determined by the first node N1, which may be before receiving the second RS, or after receiving the second RS, or may overlap with a time for receiving the second RS.

In one embodiment, an execution time for determining first reference quality is after receiving the first RS.

In one embodiment, the first message is on a PUCCH (Physical Uplink Control Channel).

The above embodiments can assist in achieving fast CSI type switching.

In one subembodiment of the above embodiment, the first message is an SR (Scheduling Request).

In one embodiment, a triggering event of the SR depends on the comparison between the received quality of the second RS and the first reference quality.

In one embodiment, the first message is on a PUSCH (Physical Uplink Shared Channel).

The above embodiments can save the radio resources occupied by physical-layer control signalings and avoid defining new UCI (Uplink Control Information).

As a response to a first condition being met, the first message is triggered:
herein, the first condition depends on the comparison between the received quality of the second RS and

the first reference quality.

In one embodiment, the first condition comprises that the received quality of the second RS exceeds a specific threshold compared to the first reference quality.

In one embodiment, when the received quality of the second RS exceeds a specific threshold compared to the first reference quality, a first counter is updated; the first condition comprises the first counter reaching a default value.

The above embodiments can avoid frequent CSI type switching caused by sudden or instantaneous performance degradation.

In one embodiment, the first counter is a MAC-layer counter, and when the received quality of the second RS exceeds a specific threshold compared to the first reference quality, the physical layer transmits an indication to the MAC layer, and the indication is used to update the first counter.

In one embodiment, the comparison between the received quality of the second RS and the first reference quality is any comparison linked with the first counter.

In one embodiment, within a first time period, if not updated, the first counter is reset to its initial value.

In one embodiment, the first time length is configurable or indicated by a downlink signaling.

In one embodiment, when Q2 continuous comparisons do not result in the first counter being updated, the first counter is reset to its initial value; Q2 is configured by a downlink signaling.

In one embodiment, Q2 is greater than 1.

In one embodiment, Q2 is 1.

In one embodiment, the being updated is plus 1, and the default value is configurable or indicated by a downlink signaling.

In one subembodiment of the above embodiment, an initial value of the first counter is 0.

In one embodiment, the being updated is minus 1, and the default value is 0.

In one subembodiment of the above embodiment, an initial value of the first counter is configurable or indicated by a downlink signaling.

In one embodiment, the second node N2 transmits a second message in step S200; the first node N1 receives a second message in step S100.

In one embodiment, the second message is used to determine that the second RS is linked with the first RS.

In one subembodiment of the above embodiment, the second message is a downlink grant DCI, the second message comprises a first field and a second field, and the first field and the second field in the second message are respectively used to indicate the first RS and the second RS.

In one embodiment, the first field is a TCI (Transmission configuration indication) field.

In one embodiment, the second field is an antenna port field.

In one subembodiment of the above embodiment, the second message is a MAC CE or RRC IE, and the second message comprises an index or identity used for indicating the first RS and an index or identity used for indicating the second RS.

In one embodiment, a name of the RRC IE comprises CSI ReportConfig, or an RRC IE is a CSI ReportConfig IE.

In one embodiment, the index used to indicate that the first RS is a CSI ResourceConfigId IE.

In one embodiment, the non-codebook precoding information indicates a precoding matrix.

In one embodiment, the precoding matrix is in spatial-frequency domain.

In one embodiment, the precoding matrix is for an angular delay domain projection.

In one embodiment, the non-codebook precoding information indicates a raw channel matrix.

In one embodiment, the raw channel matrix is in spatial-frequency domain.

In one embodiment, the raw channel matrix is in angular-delay domain.

In one embodiment, the non-codebook precoding information is used to determine a phase, an amplitude, or a coefficient between at least two antenna ports.

In one embodiment, the non-codebook precoding information is used to determine at least one feature vector. In one embodiment. the non-codebook precoding information is used to determine at least one feature value.

In one embodiment, the second message is used to indicate that a multi-antenna transmission of the second RS is codebook based.

In one subembodiment of the above embodiment, the second message is a downlink grant DCI, and the second RS is a DMRS of a PDSCH scheduled by the downlink grant.

In one subembodiment of the above embodiment, the second message indicates a first codebook type, and the multi-antenna transmission of the second RS is based on the first codebook type, candidates for the first codebook type comprise at least one of type I single-panel codebook, type I multi-panel codebook, type II codebook, enhanced type II codebook, type II port selection codebook, and enhanced type II port selection codebook.

In one subembodiment of the above embodiment, the second message indicates a first precoding matrix, the first precoding matrix is codebook-based, and the first precoding matrix is used for the multi-antenna transmission of the second RS.

In one embodiment, the first precoding matrix is a precoding matrix in an enhanced type II codebook. In one embodiment. the first precoding matrix is a precoding matrix in a type II codebook.

In one embodiment, the first precoding matrix is a precoding matrix in a type I panel codebook.

In one embodiment, the first message indicates a recommended codebook type, and a candidate for the recommended codebook type is the same as the candidate for the first codebook type.

The above embodiments help the base station quickly determine an appropriate codebook type for PMI feedback.

In one embodiment, the first reference quality depends on at least one of time-domain resources occupied by the second RS or frequency-domain resources occupied by the second RS.

CSI reference resources are frequency-domain resources and time-domain resources linked with a corresponding CSI reporting.

Taking the NR system as an example: in frequency domain, CSI reference resources comprise a group of downlink PRBs, and the group of PRBs correspond to a band linked with a derived CSI; in time domain, CSI reference resources comprise a downlink slot, the downlink slot is an n-th slot before an uplink slot occupied by a corresponding CSI reporting (i.e. the first physical-layer channel), and n is a non-negative integer. For specific definitions of CSI reference resources for NR systems, refer to chapter 5. 2. 2. 5 of TS 38. 214.

As a new type of reference quality, CSI reference resources of the first reference quality need to be additionally defined.

In one embodiment, CSI reference resources of the first reference quality comprise a slot occupied by the second RS in time domain.

In one embodiment, CSI reference resources of the first reference quality comprise a PRB (Physical Resource Block) occupied by the second RS in frequency domain.

The above embodiments can ensure fairness of the comparison.

In one embodiment, the generation of the first reference quality is based on: a wireless transmission corresponding to the first reference quality is adjusted for a first offset compared to transmit power of the first RS; the first offset is linked with the second RS.

The above embodiments can ensure fairness of the comparison.

In one embodiment, the transmit power of the first RS is measured by dBm, and the first offset is measured by dB; the adjustment is plus.

In one embodiment, the transmit power for the first RS is measured by W, the first offset is a rational number, and the adjustment is multiplication.

In one embodiment, the first offset being linked with the second RS comprises: a signaling used to schedule the second RS is used to indicate the first offset.

In one embodiment, the first offset being linked with the second RS comprises: the second RS is any of multiple RSs, and the first offset is only used for (or is only configured to) the second RS in the multiple RSs.

In one embodiment, each of the multiple RSs is used for a comparison with the first RS.

In one embodiment, each of the multiple RSs is a DMRS.

In one embodiment, each of the multiple RSs is transmitted in a slot, and the first RS is periodic.

In one embodiment, the first offset being linked with the second RS comprises: the first offset is only used for the comparison between the received quality of the second RS and the first reference quality.

In one embodiment, the first offset being linked with the second RS comprises: the second message is used to indicate the first offset.

### Embodiment 6

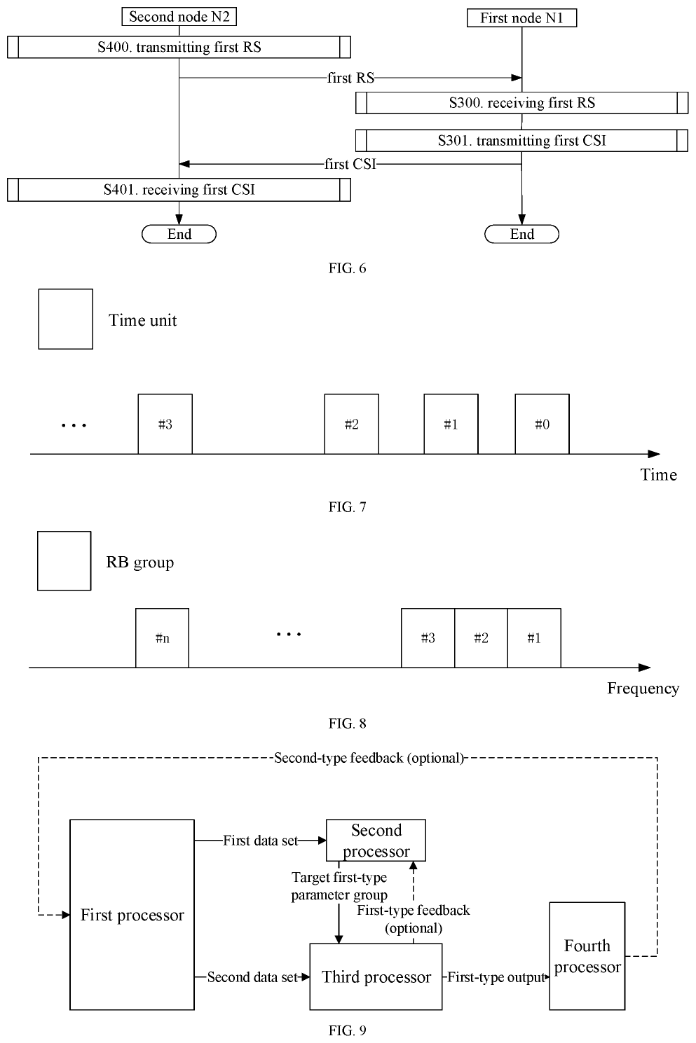

Embodiment 6 illustrates a flowchart of transmitting a first CSI according to one embodiment of the present application. as shown in FIG. 6.

A first node N1 receives a first RS in step S300, and transmits a first CSI in step S301; a second node N2 transmits a first RS in step S400 and receives a first CSI in step S402.

In embodiment 6, the first CSI comprises precoding information, and the precoding information is non-codebook.

In one embodiment, the precoding information comprised in the first CSI is different from time-domain resources (such as slot) targeted by the non-codebook precoding information on which the first reference quality depends.

In one embodiment, the precoding information comprised in the first CSI overlaps or is the same as frequency-domain resources targeted by the non-codebook precoding information on which the first reference quality depends.

In one embodiment, the first CSI is used to select the first precoding matrix. How to select the first precoding matrix based on the first CSI is determined by the second node N2 itself, or is implementation related. For example, the second node N2 selects from a codebook a precoding matrix that meets the selection criteria compared to the precoding information (represented by a precoding matrix) comprised in the first CSI; the selection criteria can be (after precoding) a largest channel capacity, or a most relevant column vector, etc.

In one embodiment, the first CSI comprises an RI, and a number of MIMO layer(s) of the precoding information (represented by a precoding matrix) comprised in the first CSI is indicated by the RI of the first CSI.

In one embodiment, the first CSI comprises a first CQI;
herein, a generation of the first CQI is based on: transmit power of a PDSCH is adjusted for a second offset compared to transmit power of the first RS.

In one embodiment, the second offset is configured by RRC, and the second offset and the first offset are independently configured.

### Embodiment 7

Embodiment 7 illustrates a schematic diagram of time-domain resources occupied by the first RS and the second RS according to one embodiment of the present application, as shown in FIG. 7. In FIG. 7, a square represents a time unit, a time unit is a slot, a subframe, or at least one multicarrier symbol.

In embodiment 7, the second RS is transmitted in a time unit identified by #1.

In one embodiment, a time unit occupied by the first RS is before a time unit occupied by the second RS (such as a time unit identified by #0).

In one embodiment, the first reference quality and the received quality of the second RS are for a same time unit, and the same time unit is before a time unit occupied by the second RS (such as a time unit identified by #2).

In one embodiment, the first reference quality and the received quality of the second RS are both for a time unit occupied by the second RS (i.e., a time unit identified by #1).

In one embodiment, the first RS is periodic, for example, occupied time units comprise time units represented by #0, #2, #3, . . .

In one embodiment, a multicarrier symbol is an Orthogonal Frequency Division Multiplexing (OFDM) symbol.

In one embodiment, a multicarrier symbol is a Discrete Fourier Transform Spread OFDM (DFT-S-OFDM) symbol.

In one embodiment, a multicarrier symbol is a Filter Bank Multi-Carrier (FBMC) symbol.

In one embodiment, a multicarrier symbol comprises a Cyclic Prefix (CP).

### Embodiment 8

Embodiment 8 illustrates a schematic diagram of CSI reference resources being on frequency domain according one embodiment of the present application, as shown in FIG. 8. In FIG. 8, a square represents a PRB group, and the PRB group comprises at least one PRB.

In one embodiment, the PRB group only comprises one PRB.

In one embodiment, a number of PRB(s) comprised in the PRB group is related to a bandwidth of the BWP (Bandwidth Part).

In one embodiment, the PRB group is a PRB bundle, and the second RS is a a DMRS.

In one embodiment, the non-codebook precoding information on which the first reference quality depends is for at least one PRB group, and a PRB group to which the received quality of the second RS is targeted is a subset of the at least one PRB group.

In one embodiment, a PRB group to which the received quality of the second RS is targeted is the same as the at least one PRB group.

### Embodiment 9

Embodiment 9 illustrates a schematic diagram of an artificial intelligence processing system according to one aspect of the present application, as shown in FIG. 9. FIG. 9 comprises a first processor, a second processor, a third processor, and a fourth processor.

In Embodiment 9, the first processor transmits a first data set to the second processor, and the second processor generates a target first-type parameter group based on the first data set, the second processor transmits the generated target first-type parameter group to the third processor, and the third processor processes the second data set by using the target first-type parameter group to obtain a first-type output, and then transmits the first-type output to the fourth processor.

In one embodiment, the third processor transmits a first-type feedback to the second processor, and the first-type feedback is used to trigger a recalculation or update of the target first-type parameter group.

In one embodiment, the fourth processor transmits a second-type feedback to the first processor, the second-type feedback is used to generate the first data set or the second data set, or the second-type feedback is used to trigger the first data set or second data set; the second-type feedback depends on the first message.

In one embodiment, the base station determines to retrain a model based on the first message reported by the UE.

In one embodiment, the first processor generates the first data set and the second data set based on a measurement for a first radio signal, and the first radio signal comprises a downlink RS (such as a CSI-RS, or an SSB, etc.).

In one embodiment, the second data set is obtained based on a measurement for the first RS resource.

In one embodiment, the first processor and the third processor belong to a first node, and the fourth processor belongs to a second node.

In one embodiment, the first-type output comprises at least first channel information.

In one embodiment, the first-type output comprises multiple non-codebook reportings, and the first channel information is one of the multiple non-codebook reportings.

In one embodiment, the second processor belongs to a first node.

The above embodiment avoids transmitting the first data set to a second node.

In one embodiment, the second processor belongs to a second node.

The above embodiments reduce the complexity of a first node.

In one embodiment, the first data set is training data, the second data set is interference data, the second processor is used to train a model, and the trained model is described by the target first-type parameter group.

In one embodiment, the third processor constructs a model based on the target first-type parameter set, and then inputs the second data set into the constructed model to obtain the first-type output, and the first-type output is then transmitted to the fourth processor.

In one subembodiment of the above embodiment, the third processor comprises a first encoder in the present application, the first encoder is described by the target first-type parameter group, and a generation of the first-type output is executed by the first encoder.

In one embodiment, the third processor calculates an error between the first-type output and actual data to determine the performance of the trained model; the actual data is data received after the second data set and transmitted by the first processor.

The above embodiments are particularly suitable for predicting relevant reportings.

In one embodiment, the third processor recovers a reference data set based on the first-type output, and an error between the reference data set and the second data set is used to generate the first-type feedback.

The recovery of the reference data set usually adopts an inverse operation similar to the target first-type parameter group, and the above embodiments are particularly suitable for CSI compression related reportings.

In one embodiment, the first-type feedback is used to reflect the performance of the trained model; when the performance of the trained model cannot meet requirements, the second processing occasion recalculates the target first-type parameter group.

In one subembodiment of the above embodiment, the third processor comprises a first reference decoder in the present application, and the first reference decoder is described by the target first-type parameter group; an input of the first reference decoder comprises the first-type output, and an output of the first reference decoder comprises the reference data set.

Typically, when an error is too large or has not been updated for too long, the performance of the trained model is considered inadequate.

In one embodiment, the third processor belongs to the second node, and the first node reports the target first-type parameter group to the second node.

In one embodiment, the first channel information comprises the precoding information in the first CSI.

In one embodiment, the first channel information comprises the non-codebook precoding information on which the first reference quality depends.

In one embodiment, compared to the first channel information or the precoding information in the first CSI, generation methods of the non-codebook precoding information on which the first reference quality depends are the same, with the difference being that it is transmitted to the first decoder not through an air interface.

### Embodiment 10

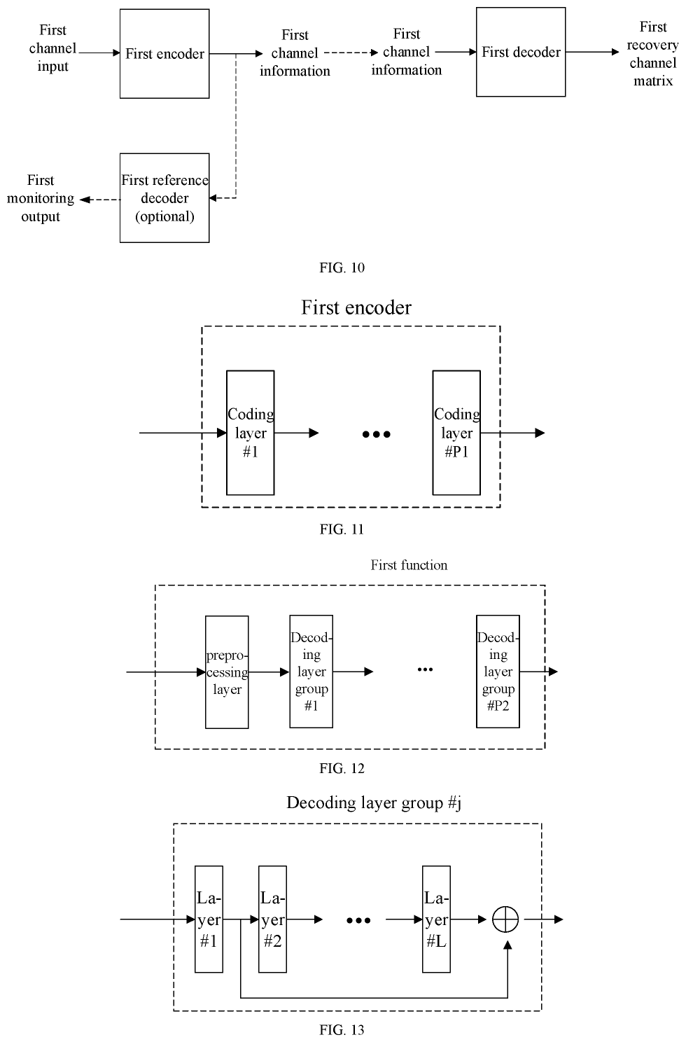

Embodiment 10 illustrates a flowchart of a transmission of first channel information according to one embodiment of the present application, as shown in FIG. 10. In FIG. 10, a first reference decoder is optional.

In Embodiment 10, a first encoder and a first decoder respectively belong to a first node and a second node; herein, the first encoder belongs to a first receiver, and the first decoder belongs to a second receiver.

The first receiver generates the first channel information using a first encoder; herein, an input of the first encoder comprises a first channel input, and the first encoder is obtained through training; the first channel input is obtained based on a measurement for a first RS resource group;
the first node feedbacks the first channel information to the second node through an air interface;
the second receiver generates a first recovered channel matrix using a first decoder; herein, an input of the first decoder comprises the first channel information, and the first decoder is obtained through training.
the first encoder and the first decoder should theoretically be mutually inverse to ensure that the first channel input is the same as the first recovered channel matrix.

In one embodiment, due to factors such as implementation complexity or radio overhead or delay, the first encoder and the first decoder in embodiment 10 cannot be ensured to be completely cancelled out, so that the first channel input and the first recovered channel matrix cannot be ensured to be exactly the same, resulting in a different understanding between the two parties as to a precoding matrix represented by the first channel information.

In one embodiment, the first channel input is a raw channel matrix.

In one embodiment, the first channel input is a precoding matrix.

In one embodiment, the first receiver further comprises a first reference decoder, an input of the first reference decoder comprises the first channel information, and an output of the first reference decoder comprises a first monitoring output.

In one embodiment, the first channel matrix is the first monitoring output and the first reference decoder cannot be considered identical to the first decoder.

In the above embodiments, the first reference decoder and the first decoder may be independently generated or independently maintained, so that although they are both intended to perform an inverse operation of the first encoder, the two may be only approximate.

In one embodiment, the first receiver comprises a third processor in embodiment 7.

In one embodiment, the first channel input belongs to a second data set in embodiment 7.

In one embodiment, the training of the first encoder is performed at the first node.

In one embodiment, the training of the first encoder is performed by the second node.

In one embodiment, the first recovered channel matrix is known only to the second node.

In one embodiment, the first recovered channel matrix cannot be considered identical to the first channel matrix.

In one embodiment, the first channel information comprises the precoding information in the first CSI.

In one embodiment, the first channel information comprises the non-codebook precoding information on which the first reference quality depends.

In one embodiment, compared to the first channel information or the precoding information in the first CSI, generation methods of the non-codebook precoding information on which the first reference quality depends are the same, with the difference being that it is transmitted to the first decoder not through an air interface.

### Embodiment 11

Embodiment 11 illustrates a schematic diagram of a first encoder according to one embodiment of the present application, as shown in FIG. 11. In FIG. 11, the first encoder comprises P1 coding layers, namely coding layers #1, #2, . . . #P1.

In one embodiment, P1 is 2, that is, the P1 coding layers comprise coding layer #1 and coding layer #2, and the coding layer #1 and coding layer #2 are respectively a convolutional layer and a fully-connected layer; in the convolutional layer, at least one convolutional kernel is used to convolve the first channel input to generate a corresponding feature map, and at least one feature map output by the convolution layer is reshaped as a vector to input to the fully-connected layer; the fully-connected layer converts the vector as first channel information. For a more detailed description, refer to CNN-related technical literature, e.g., Chao-Kai Wen, Deep Learning for Massive MIMO CSI Feedback, IEEE WIRELESS COMMUNICATIONS LETTERS, VOL. 7, NO. 5, October 2018 and etc.

In one embodiment, P1 is 3, that is, the P1 coding layers comprise a fully-connected layer, a convolutional layer and a pooling layer.

### Embodiment 12

Embodiment 12 illustrates a schematic diagram of a first function according to one embodiment of the present application, as shown in FIG. 12. In FIG. 12, the first function comprises a preprocessing layer and P2 decoding layer groups. namely decoding layer groups #1, #2, . . . , #P2. Each decoding layer group comprises at least one decoding layer.

The structure of the first function is applicable to a first decoder and a first reference decoder in embodiment 8.

In one embodiment, the preprocessing layer is a fully-connected layer that expands a size of the first channel information to a size of the first channel input.

In one embodiment, any two of the P2 decoding layer groups have a same structure, the structure comprises a number of comprised decoding layer(s) as well as a size of input parameters and a size of output parameters of each comprised decoding layer and etc.

In one embodiment, the second node indicates the structure of the P2 and the decoding layer group to a first node, and the first node indicates other parameters of the first function through the second signaling.

In one embodiment, the other parameters comprise at least one of a threshold of an activation function, a size of a convolution kernel, a step size of a convolution kernel, or a weight between feature maps.

### Embodiment 13

Embodiment 13 illustrates a schematic diagram of a decoding layer group according to one embodiment of the present application, as shown in FIG. 13. In FIG. 13, a decoding layer group #j comprises L layers, that is, layers #1, #2, . . . , #L; the decoding layer group is any of the P2 decoding layer groups.

In one embodiment, L is 4, a first one layer of the L layers is an input layer, and the last three layers of the L layers are all convolutional layers, and for a more detailed description, refer to CNN-related technical literature, e.g., Chao-Kai Wen, Deep Learning for Massive MIMO CSI Feedback, IEEE WIRELESS COMMUNICATIONS LETTERS, VOL. 7, NO. 5, October 2018 and etc.

In one embodiment, the L layers comprise at least one convolutional layer and a pooling layer.

### Embodiment 14

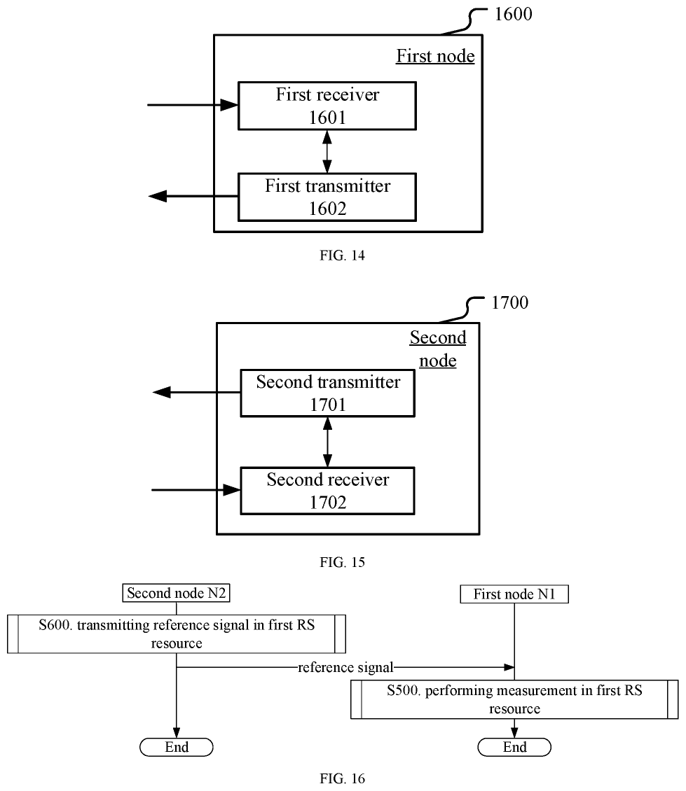

Embodiment 14 illustrates a structure block diagram of a processor in a first node according to one embodiment of the present application, as shown in FIG. 14. In FIG. 14, a processor 1600 in a first node comprises a first receiver 1601 and a first transmitter 1602.

The first receiver 1601 receives a first RS; determines first reference quality, where the first reference quality depends on non-codebook precoding information; receives a second RS, where the second RS is linked with the first RS; the first transmitter 1602 transmits a first message, and the first message depends on a comparison between received quality of the second RS and the first reference quality;

In embodiment 14, both the first reference quality and the non-codebook precoding information depend on a measurement for the first RS.

In one embodiment, the first receiver 1601 receives a second message; herein, the second message is used to determine at least one of the following:
a multi-antenna transmission of the second RS is codebook-based;
the second message is used to indicate a first precoding matrix, the first precoding matrix is codebook-based, and the first precoding matrix is used for the multi-antenna transmission of the second RS;
the second RS is linked with the first RS.

In one embodiment, as a response to a first condition being met, the first message is triggered; herein, the first condition depends on the comparison between the received quality of the second RS and the first reference quality.

In one embodiment, the first transmitter 1602 transmits the non-codebook precoding information.

In one embodiment, the generation of the first reference quality is based on: a wireless transmission corresponding to the first reference quality is adjusted for a first offset compared to transmit power of the first RS; the first offset is linked with the second RS.

In one embodiment, the first reference quality depends on at least one of time-domain resources occupied by the second RS or frequency-domain resources occupied by the second RS.

In one embodiment, a calculation of the first reference quality is conditional on a number of antenna port(s) of the second RS.

In one embodiment, the first node 1600 is a UE.

In one embodiment, the first transmitter 1602 comprises at least one of the antenna 452, the transmitter/receiver 454, the multi-antenna transmitting processor 457, the transmitting processor 468, the controller/processor 459, the memory 460 or the data source 467 in FIG. 4 of the present application.

In one embodiment, the first transmitter 1602 comprises the antenna 452, the transmitter/receiver 454, the multi-antenna transmitting processor 457, the transmitting processor 468, the controller/processor 459, the memory 460 and the data source 467 in FIG. 4 of the present application.

In one embodiment, the first receiver 1601 comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver 1601 comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver 1601 comprises at least the first three of the antenna 452, the receiver 454, the multi-antenna receiving processor 458, the receiving processor 456, the controller/processor 459, the memory 460 and the data source 467 in FIG. 4 of the present application.

### Embodiment 15

Embodiment 15 illustrates a structure block diagram of a processor in a second node according to one embodiment of the present application, as shown in FIG. 15. In FIG. 15, a processor 1700 in the second node comprises a second transmitter 1701 and a second receiver 1702.

The second transmitter 1701 transmits a first RS; transmits a second RS, where the second RS is linked with the first RS; the second receiver 1702 receives a first message, and the first message depends on a comparison between received quality of the second RS and first reference quality;

in embodiment 15, the first reference quality depends on non-codebook precoding information; both the first reference quality and the non-codebook precoding information depend on a measurement for the first RS.

In one embodiment, the second transmitter 1701 transmits a second message; herein, the second message is used to determine at least one of the following:
a multi-antenna transmission of the second RS is codebook-based;
the second message is used to indicate a first precoding matrix, the first precoding matrix is codebook-based, and the first precoding matrix is used for the multi-antenna transmission of the second RS;
the second RS is linked with the first RS.

In one embodiment, as a response to a first condition being met, the first message is triggered; herein, the first condition depends on the comparison between the received quality of the second RS and the first reference quality.

In one embodiment, the second receiver 1702 receives the non-codebook precoding information.

In one embodiment, the generation of the first reference quality is based on: a wireless transmission corresponding to the first reference quality is adjusted for a first offset compared to transmit power of the first RS; the first offset is linked with the second RS.

In one embodiment, the first reference quality depends on at least one of time-domain resources occupied by the second RS or frequency-domain resources occupied by the second RS.

In one embodiment, a calculation of the first reference quality is conditional on a number of antenna port(s) of the second RS.

In one embodiment, the second node 1700 is a base station.

In one embodiment, the second transmitter 1701 comprises the antenna 420, the transmitter 418, the transmitting processor 416 and the controller/processor 475.

In one embodiment, the second transmitter 1701 comprises the antenna 420, the transmitter 418, the multi-antenna transmitting processor 471, the transmitting processor 416 and the controller/processor 475.

In one embodiment, the second transmitter 1701 comprises the antenna 420, the transmitter 418, the transmitting processor 416 and the controller/processor 475.

In one embodiment, the second transmitter 1701 comprises the antenna 420, the transmitter 418, the multi-antenna transmitting processor 471, the transmitting processor 416 and the controller/processor 475.

In one embodiment, the second receiver 1702 comprises the antenna 420, the receiver 418, the multi-antenna receiving processor 472, the receiving processor 470 and the controller/processor 475.

In one embodiment, the second receiver 1702 comprises the controller/processor 475.

### Embodiment 16

Embodiment 16 illustrates a flowchart of performing a measurement in a first RS resource group according to one embodiment of the present application, as shown in FIG. 16. The first RS resource group comprises a first RS resource, and the first RS resource is configured to the first RS.

The first node N1 performs a measurement in a first RS resource group in step S500; the second node N2 transmits a reference signal in at least partial RS resources in a first RS resource group.

In one embodiment, the at least partial RS resources comprise a first RS resource used for channel measurement.

The specific implementation of the measurements performed by the first node N1 in the first RS resource group is at the discretion of the hardware appliance vendor, and a non-limiting example is given below:
the first node measures a channel parameter matrix for each PRB, the channel parameter matrix being of Nt rows and Nr columns, where each element is a channel impulse response; the Nt and the Nr are respectively a number of antenna port(s) and a number of receiving antenna(s) in an RS resource; the first node combines channel parameter matrices measured on all PRBs within a PRB group to obtain a channel matrix for each PRB group. An input to a first encoder comprises a channel matrix for partial or all subbands in a first frequency-band resource group, or, an input to a first encoder comprises a feature vector of a channel matrix for partial or all subbands in a first frequency-band resource group.

In one embodiment, the second node N2 maintains zero power in at least one RS resource in a first RS resource group, and the at least one RS resource is used for interference measurements.

In one embodiment, the PRB group is a subband in a BWP.

In one embodiment, the first frequency-band resource group is a BWP.

In one embodiment, the first frequency-band resource group comprises multiple PRB groups.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, wireless sensors, network cards, Internet of Things (IoT) terminals, RFID terminals, NB-IOT terminals, Machine Type Communication (MTC) terminals, enhanced MTC (eMTC) terminals, data card, network cards, vehicle-mounted communication equipment, low-cost mobile phones, low-cost tablets and other wireless communication devices. The UE and terminal in the present application include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, RFID terminals, NB-IOT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

It will be appreciated by those skilled in the art that this application can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first RS; determining first reference quality, where the first reference quality depending on non-codebook precoding information; receiving a second RS, where the second RS being linked with the first RS; and
a first transmitter, transmitting a first message, the first message depending on a comparison between received quality of the second RS and the first reference quality;
wherein both the first reference quality and the non-codebook precoding information depend on a measurement for the first RS.

2. The first node according to claim 1, comprising:
the first receiver, receiving a second message;
wherein the second message is used to determine at least one of the following:
a multi-antenna transmission of the second RS is codebook-based;
the second message is used to indicate a first precoding matrix, the first precoding matrix is codebook-based, and the first precoding matrix is used for the multi-antenna transmission of the second RS;
the second RS is linked with the first RS.

3. The first node according to claim 1, wherein as a response to a first condition being satisfied, the first message is triggered;
wherein the first condition depends on the comparison between the received quality of the second RS and the first reference quality.

4. The first node according to claim 1, comprising:
the first transmitter, transmitting the non-codebook precoding information.

5. The first node according to claim 1, wherein the generation of the first reference quality is based on: a wireless transmission corresponding to the first reference quality is adjusted for a first offset compared to transmit power of the first RS; the first offset is linked with the second RS.

6. The first node according to claim 1, wherein the first reference quality depends on at least one of time-domain resources occupied by the second RS or frequency-domain resources occupied by the second RS.

7. The first node according to claim 1, wherein a calculation of the first reference quality is conditional on a number of antenna port(s) of the second RS.

8. A second node for wireless communications, comprising:
a second transmitter, transmitting a first RS; transmitting a second RS, where the second RS being linked with the first RS; and
a second receiver, receiving a first message, the first message depending on a comparison between received quality of the second RS and first reference quality;
wherein the first reference quality depends on non-codebook precoding information; both the first reference quality and the non-codebook precoding information depend on a measurement for the first RS.

9. The second node according to claim 8, comprising:
the second transmitter, transmitting a second message; wherein the second message is used to determine at least one of the following:
a multi-antenna transmission of the second RS is codebook-based;
the second message is used to indicate a first precoding matrix, the first precoding matrix is codebook-based, and the first precoding matrix is used for the multi-antenna transmission of the second RS;
the second RS is linked with the first RS.

10. The second node according to claim 8, comprising:
as a response to a first condition being met, the first message is triggered; wherein the first condition depends on the comparison between the received quality of the second RS and the first reference quality.

11. The second node according to claim 8, comprising:
the second receiver, receiving the non-codebook precoding information.

12. The second node according to claim 8, comprising:
the generation of the first reference quality is based on: a wireless transmission corresponding to the first reference quality is adjusted for a first offset compared to transmit power of the first RS; the first offset is linked with the second RS.

13. The second node according to claim 8, comprising:
the first reference quality depends on at least one of time-domain resources occupied by the second RS or frequency-domain resources occupied by the second RS.

14. A method in a first node for wireless communications, comprising:
receiving a first RS; determining first reference quality, where the first reference quality depending on non-codebook precoding information; receiving a second RS, where the second RS being linked with the first RS; and
transmitting a first message, the first message depending on a comparison between received quality of the second RS and the first reference quality;
wherein both the first reference quality and the non-codebook precoding information depend on a measurement for the first RS.

15. The method in a first node according to claim 14, comprising:
receiving a second message; and
wherein the second message is used to determine at least one of the following:
a multi-antenna transmission of the second RS is codebook-based;
the second message is used to indicate a first precoding matrix, the first precoding matrix is codebook-based, and the first precoding matrix is used for the multi-antenna transmission of the second RS;
the second RS is linked with the first RS.

16. The method in a first node according to claim 14, wherein as a response to a first condition being satisfied, the first message is triggered;
wherein the first condition depends on the comparison between the received quality of the second RS and the first reference quality.

17. The method in a first node according to claim 14, comprising:
transmitting the non-codebook precoding information.

18. The method in a first node according to claim 14, wherein the generation of the first reference quality is based on: a wireless transmission corresponding to the first reference quality is adjusted for a first offset compared to transmit power of the first RS; the first offset is linked with the second RS.

19. The method in a first node according to claim 14, wherein the first reference quality depends on at least one of time-domain resources occupied by the second RS or frequency-domain resources occupied by the second RS.

20. The method in a first node according to claim 14, wherein a calculation of the first reference quality is conditional on a number of antenna port(s) of the second RS.
